(19) United States
(12) Patent Application Publication
(10) Pub. No.: US 2026/0027892 A1
(43) Pub. Date: Jan. 29, 2026

(54) ELECTRIC DRIVE ASSEMBLY

(71) Applicant: GKN Automotive Limited, Birmingham (GB)

(72) Inventors: Hanspeter Putzer, Bruneck (IT); Thomas Messner, Bruneck (IT)

(21) Appl. No.: 19/274,881

(22) Filed: Jul. 21, 2025

(30) Foreign Application Priority Data
Jul. 26, 2024 (DE) 102024002444.1

(51) Int. Cl. B60K 17/16; F16H 1/28; F16H 57/08

(52) U.S. Cl. CPC B60K 17/18; F16H 1/28; F16H 2057/085

(57) ABSTRACT

An electric drive assembly for driving a motor vehicle, comprising a housing, an electric machine with a motor shaft designed as a hollow shaft which is rotatably drivable about an axis of rotation; a planetary gearing; a differential unit with a differential, a disc clutch for adjusting a locking effect of the differential and a controllable ball ramp mechanism for actuating the disc clutch, wherein a side gear of the differential has an inner spline for inserting a shaft and a disc carrier portion which at least partially have an axial overlap; wherein the disc clutch is arranged inside and the ball ramp mechanism is arranged outside the differential carrier.

### CROSS REFERENCE TO RELATED APPLICATIONS

This application claims priority to German Patent Application No. DE102024002444.1 filed on Jul. 26, 2024, and the entire content of this priority application is incorporated herein by reference in its entirety.

### TECHNICAL FIELD

The disclosure relates to an electric drive for driving a motor vehicle. An electric drive generally comprises an electric machine, a reduction gearing which reduces a rotary movement introduced by the electric machine to a low speed, and a power distribution unit which distributes the rotary movement introduced by the reduction gearing to two output shafts. Electric drives of this type can also be referred to as electric drive assemblies or electric axles.

### BACKGROUND

A drive assembly for a vehicle drive is known from CN 207931450 U with an electric motor, a reduction gearing, a differential mechanism, a clutch and side shafts. The electric motor is drivingly connected to the reduction gearing, which in turn is drivingly connected to the differential mechanism. The reduction gearing is designed in the form of a planetary gearing comprising several pairs of planetary gears, each including two planetary gears. The pairs of planetary gears are rotatably arranged on the differential carrier of the differential mechanism. A first planetary gear is driven by a sun gear connected to the drive shaft of the electric motor. A smaller second planetary gear can be coupled to a stationary housing by means of the clutch.

An electric drive for driving a motor vehicle is known from WO 2020/069744 A1. The electric drive comprises a housing assembly, an electric machine with a motor shaft designed as a hollow shaft, a planetary unit with a sun gear, a ring gear, several planet gears and a planet carrier, a power distribution unit with an input part and two output parts. The input part is connected to the planet carrier and rotates together therewith around the axis of rotation. One of the two output parts is connected to an intermediate shaft that extends through the hollow shaft of the electric machine.

A differential gearing is known from WO 2005/064206 A1, in which the differential basket has a cup-shaped basket part, in which the side gears and differential gears are accommodated, and a cup-shaped cover attached thereto, in which the discs of the disc clutch are accommodated. A sleeve is arranged outside of the cover, on which an actuator for the locking clutch can be axially supported, and on which the actuator can also be radially supported. The actuator comprises a ball ramp mechanism.

From DE 10 2022 202 378 A1, a transmission with an input shaft, two output shafts and a differential is known. The differential comprises two planetary gear sets, each with three gear set elements.

A differential assembly with an actuator assembly is known from DE 10 2023 122 917 A1.

From DE 10 2022 133 320 A1, an electric drive device is known comprising a braking device for braking a vehicle wheel.

There is a technical need to provide a controllable differential lock function, respectively limited slip function, for electric drive systems including a differential gearing. At the same time, there is a desire for an efficient and compact design.

An object of at least some implementations of the present disclosure is to propose a drive assembly with an electric motor and differential gearing with controllable locking function, which has a compact design.

### SUMMARY

An electric drive for driving a motor vehicle is proposed as a solution, comprising a housing; an electric machine with a motor shaft in the form of a hollow shaft which is rotatably drivable by the electric machine about an axis of rotation; a planetary gearing with a sun gear, a ring gear, a plurality of planet gears and a planet carrier on which the planet gears are rotatably supported, wherein the sun gear is rotatably drivable about the axis of rotation by the hollow shaft, and the ring gear is connected to the housing in a rotationally fixed manner; a differential unit with a differential, a disc clutch for adjusting a locking effect of the differential and a controllable ball ramp mechanism for actuating the disc clutch; wherein a differential carrier of the differential and the planet carrier are designed as a unitary, in particular housing-shaped carrier element which is mounted in the housing so as to be rotatable about the axis of rotation; wherein a first side gear of the differential is connected to a first intermediate shaft which extends through the hollow shaft of the electric machine, and a second side gear of the differential includes inner splines for inserting a second intermediate shaft and a disc carrier portion for a disc pack of the disc clutch, wherein the inner splines and the disc carrier portion have at least partial axial overlap; wherein the ball ramp mechanism is arranged outside the differential carrier coaxially around a sleeve portion of the differential carrier and comprises an axially supported support ring and an axially movable setting ring; wherein the differential carrier comprises a side wall portion having a plurality of through openings distributed circumferentially through which force transmitting elements extend axially to transmit an axial movement of the setting ring to a pressure plate for loading the disc pack.

An advantage of the electric drive is the integration of a controllable locking clutch for limiting the differential effect of the differential as required, while at the same time having a compact design with a smaller number of parts. Overall, this results in an improvement in the driving dynamics properties, with only minor adjustments to the packaging required on the vehicle side. The integral design of the planet carrier with the differential carrier as one carrier part results in a space-saving structure. The integral, respectively unitary carrier part fulfils three functions, namely planet carrier for the planetary gears, differential carrier for the differential gears and outer disc carrier for the outer discs of the friction disc clutch. The unit formed by the planetary gearing and the limited slip differential can have a common oil reservoir.

The housing-shaped carrier element may be compact in design. For this purpose, the carrier element can be designed in such a way that the largest outer diameter in the area of the planet carrier is smaller than 1.25 times the largest outer diameter in the area of the differential carrier. Alternatively, or additionally, the carrier element is designed in such a way that the planetary gears rotatably mounted therein have at least partial axial overlap with the side gears also rotatably mounted in the carrier element.

In particular, the planet carrier has several radial windows distributed around the circumference through which the planet gears pass respectively extend. An inner meshing area of the planet gears with the sun gear is located inside the housing-shaped planet carrier, and an outer meshing area of the planet gears with the ring gear is located outside the housing-shaped planet carrier. For a particularly compact design, an axial distance from the center plane of the window to the center plane of the differential can be smaller than an axial distance from the center plane of the differential to an end bearing via which the differential carrier is rotatably mounted in the housing. The unitary or one-piece carrier element can be produced as a cast part from a light metal or a light metal alloy, for example an aluminum alloy.

The friction disc clutch, which can also be referred to as multi-plate clutch, is effectively arranged between the differential carrier and the second side gear, i.e. a locking effect is generated between the differential carrier and the side gear by applying pressure to the disc pack. The disc pack comprises outer discs connected to the differential carrier in a rotationally fixed and axially movable manner, and inner discs connected to the second side gear in a rotationally fixed and axially movable manner. The disc pack can be acted upon axially by a pressure plate, respectively pressure ring, and is supported axially against a contact surface associated with the differential carrier. For this purpose, a support ring can be arranged respectively inserted in the differential carrier, via which the disc pack is axially supported. The use of a support ring opens up further possibilities in terms of design, wherein it is understood that the disc pack can also be supported directly against the differential carrier. The friction disc clutch can be designed in such a way that it can transmit a target clutch torque of more than 1600 Nm, in particular more than 1700 Nm, for example approx. 1800 Nm. A factor representative of the power density and/or radial size, derived from the largest outer diameter of the differential carrier, specified in millimeters, and the transmittable clutch torque, specified in Nm, can be less than 0.9, in particular less than 0.8.

For example, the support ring can be designed so that the inner diameter is smaller than the smallest inner diameter of the differential insertion opening and/or smaller than the average diameter of the disc pack and/or smaller than the largest outer diameter of the second side gear. The insertion opening of the differential carrier can be larger than the mean diameter of the disc pack. On the side facing the differential gear set, the support ring can have an annular face that tapers in the direction of the disc pack, in particular a conical face. These features individually or together contribute to good axial support of the disc pack with a compact design. A radially largest portion of the side gear can be arranged with axial overlap to the support ring and/or as close as possible axially to the disc pack. The support ring can also have a holding section that protrudes axially from the support face and is seated in the insertion opening of the differential carrier. In this way, the support ring is held and/or centered radially in relation to the differential carrier.

The differential carrier may comprise a side wall portion adjoining the sleeve portion, through which the force transmission elements extend. An actuating element can be arranged coaxially to the sleeve portion between the setting ring of the ball ramp mechanism and the force transmission elements, wherein an annular gap is formed between an outer surface of the sleeve portion and the actuating element. The side wall portion can be inserted into a recess in the casing portion of the differential carrier and firmly connected thereto, in particular by welding.

The ball ramp assembly is rotatably drivable by a drive source, for example a controllable electric motor, and is designed to convert an initiated rotary movement into an axial movement. For this purpose, the setting ring and the support ring can each have a decreasing depth in the same circumferential direction when viewed in plan view of the end faces. A ball is accommodated in each pair of opposing ball grooves, via which the setting ring and the support ring are axially supported against each other. The setting ring may be radially supported with respect to the support ring exclusively via the balls. No further radial bearing is required for the setting ring, so that an annular gap can be formed between the outer surface of the sleeve portion and the setting ring. This in turn has a positive effect on the design freedom for the sleeve portion, which can be optimized in terms of installation space and stress.

A spring element may be arranged axially between the side wall portion and the actuating element in order to exert a resilient restoring force on the actuating element that opposes the actuating force of the ball ramp mechanism. The spring element can have any design that is suitable for moving the actuating element back in the initial direction against the operating direction of the setting ring. For example, the spring can have an annular shape and be seated in a recess and/or axial depression in the side wall of the differential carrier. To prevent jamming, the spring is held with radial play relative to a circumferential surface of the side wall. In particular, the spring element can be designed as a wave spring or disc spring, although other designs are also possible, such as several coil springs distributed around the circumference.

According to an embodiment, an axial bearing can be arranged between the setting ring and the actuating element. The axial bearing transmits axial forces between the setting ring and the actuating element, both in the closing direction and in the opening direction. At the same time, the axial bearing, which can also be referred to as thrust bearing, decouples relative rotational movements of the two elements in relation to each other.

According to an embodiment, the supporting ring of the ball ramp mechanism is rotatably drivable by a drive source, while the setting ring is rotationally fixed and axially movable. It is understood that other embodiments are also possible, for example that the setting ring is rotatably drivable and is axially movable, while the support ring is rotationally fixed and axially supported. The support ring and setting ring have ball grooves on their facing end faces that vary in depth in the circumferential direction. The ball ramp mechanism can be designed such that the centers of the balls held in the ball grooves have radial overlap with the axial bearing and/or with the support bearing for the support ring. This results in an advantageous axial force transmission with low tilting moments.

According to an embodiment, the sleeve portion of the differential carrier has a bearing seat on which a rotary bearing for the support ring is mounted. The differential carrier can comprise, viewed in half-longitudinal section, a concave transition portion between the axial side face and the bearing face of the sleeve portion, which can extend axially from the side face at least as far as the setting ring. The transition portion may have a free outer face, which may be at least as far as the support ring, which means that no components are mounted on the housing part between the end face and the support ring and/or the support bearing. This section of the housing part, which is subject to high forces during operation, can therefore be designed or configured to optimize stresses, which has a favorable effect on the service life of the assembly.

A smallest outer diameter of the concave transition portion can be smaller than the outer diameter of the bearing seat for the rotary bearing. Alternatively, or additionally, the concave transition portion can have a curvature whose radius is at least 0.5 times a smallest axial distance between the setting ring and the flange portion of the differential carrier. Alternatively, or additionally, the smallest outer diameter of the concave transition portion can be smaller than the radius of the external toothing of the clutch hub. The load on the differential carrier in this section can be reduced by one or more of these features.

The differential has several differential gears which are mounted in the differential carrier so that they can rotate about gear axes extending at an angle to the axis of rotation of the differential carrier, and the two side gears which are mounted in the differential carrier coaxially to the axis of rotation and mesh with the differential gears. The gear axes of the differential gears form the differential center plane. The differential can be designed as a bevel gear differential, wherein the differential gears and the side gears are each designed as bevel gears. Alternatively, the differential can also be designed as a crown gear differential, with the differential gears being designed as spur gears and the side gears being designed as crown gears. The side gears can be drivingly connected to side shafts of the vehicle and thus may also be referred to as side shaft gears.

### BRIEF DESCRIPTION OF THE DRAWINGS

Certain embodiments are explained below with reference to the drawing figures. Herein:

FIG. 1A shows a longitudinal section of an electric drive assembly in a first embodiment;

FIG. 1B shows the differential unit of the electric drive assembly from FIG. 1A as a detail in an enlarged view;

FIG. 2 shows a schematic representation of the electric drive assembly of FIG. 1A;

FIG. 3 shows the differential unit of an electric drive assembly in a second embodiment in longitudinal section.

### DETAILED DESCRIPTION

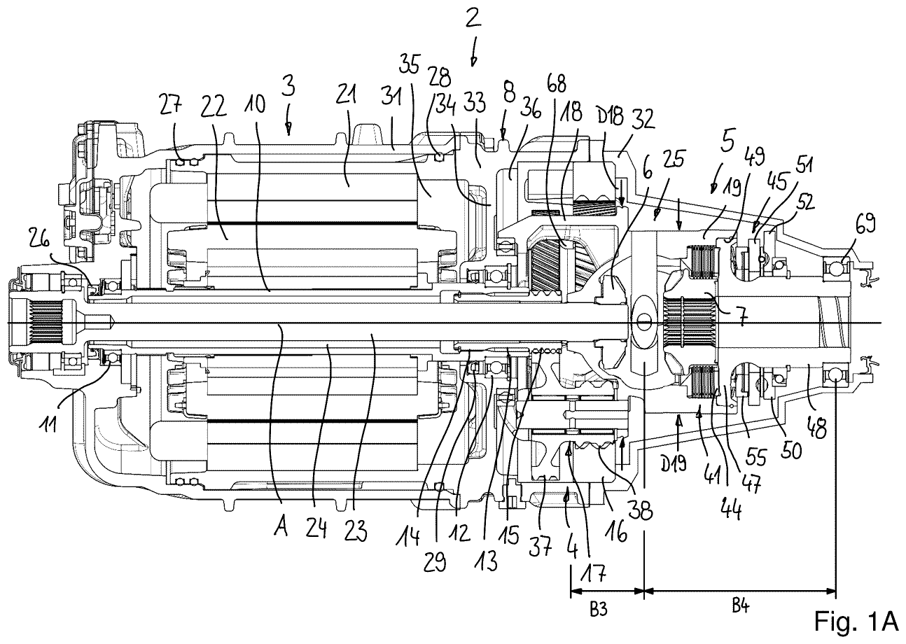

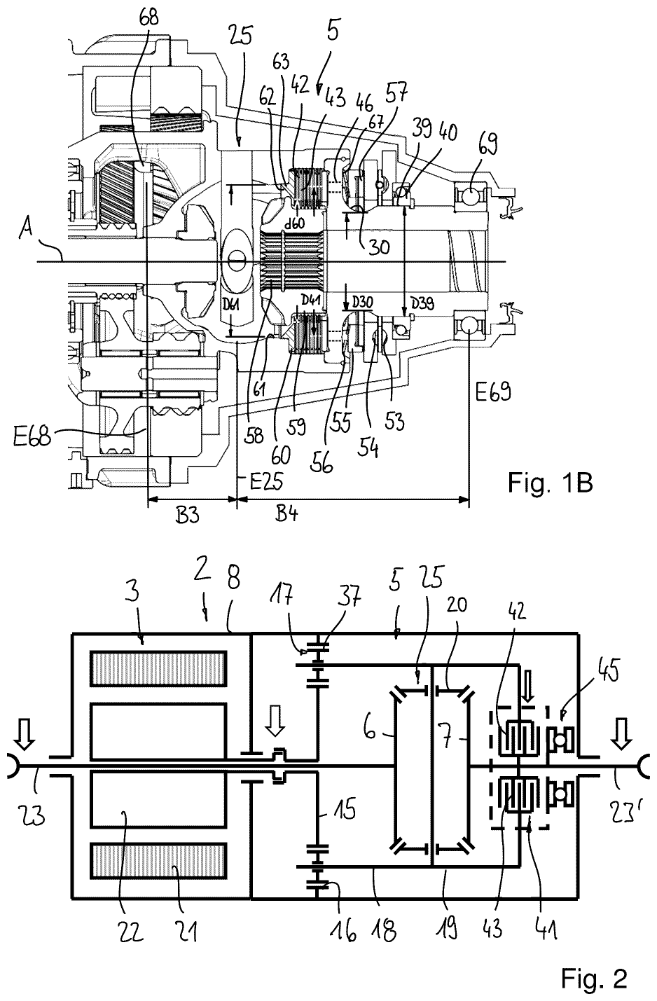

FIGS. 1A, 1B and 2 are described together below. An electric drive assembly 2 is shown, which can also be referred to as an electric drive for short. The electric drive assembly 2 comprises an electric machine 3, a planetary gearing 4, which is drivingly connected to the electric machine 3, and a differential unit 5 for distributing a rotary motion initiated by the planetary gearing 4 to two output parts 6, 7 of the electric drive assembly 2. The electric machine 3, the planetary gearing 4 and the differential unit 5 are accommodated in a housing assembly, which can also be referred to briefly as housing 8. The differential unit 5 comprises a disc clutch 41 for locking an equalising or differential movement of the differential output parts, and a ball ramp mechanism 45 for controlling the clutch torque, respectively locking torque. In this respect, the differential unit can also be referred to as a limited slip differential unit.

The electric machine 3 serves as a drive source for driving a drive axle of a motor vehicle. The electric machine 3 is controlled by means of power electronics, such as a pulse inverter, with an integrated electronic control unit (ECU). The electric machine 3 must be connected to a battery (not shown) for the power supply. The electric machine 3 has a stator 21, which is permanently connected to the housing 8, and a rotor 22, which is permanently connected to a motor shaft 10 for torque transmission.

The motor shaft 10 is designed as a hollow shaft and is rotatably mounted in the housing 8 about the axis of rotation A by a first and second bearing 11, 12 and is rotatably drivable by the rotor 9. A drive member 13 is provided at the shaft end towards the gearing 4, which is connected in a rotationally fixed manner to the hollow shaft 10 via a shaft connection 14 (splines) and which serves to transmit the rotary motion to the planetary gearing 4. The planetary gearing 4 comprises a sun gear 15, which is integrally formed with the drive member 13, a ring gear 16, which is connected in a rotationally fixed manner in the housing 8, several planet gears 17 and a planet carrier 18, on which the planet gears 17 are rotatably mounted and rotate together therewith.

In the present embodiment, the planetary gears 17 are designed as double planetary gears, without being limited thereto, and each have a first planet gear toothing 37, which meshes with the sun gear 15, and a second planet gear toothing 38, which meshes with the ring gear 16. The toothing 37, 38 of the planetary gears 17 can be designed as helical toothing, so that the axial forces acting from the sun gear 15 on the first planet gear toothing 37 and those acting from the ring gear 16 on the second planet gear toothing 38 are directed in opposite directions.

The ring gear 16 is connected to a housing part 32 of the housing 8, for example by means of screws that can be screwed axially into the housing part 32. The planet carrier 18 is firmly connected to the input part of the differential unit 5, so that both rotate together about the axis of rotation A. The differential unit 5 comprises a differential carrier 19 as input part, a plurality of differential gears 20 rotating together with the differential carrier 19, and two side gears 6, 7 as output parts meshing with the differential gears 20. The differential gears 20 and the side shaft gears 6, 7 are each designed as bevel gears, without being limited thereto. The differential unit 5 distributes an initiated rotary movement to the two side gears 6, 7, wherein there is a balancing, i.e. differential effect between the side gears due to the differential gears 20 arranged therebetween. The planet carrier 18 and the differential carrier 19, which can also be referred to as differential cage or basket, are designed in one piece in the present case. The component thus formed can also be jointly referred to as the carrier element.

The carrier element is shaped like a housing and can, for example, be produced as a cast part from a light metal or a light metal alloy, in particular an aluminum alloy. This also allows more complex shapes to be designed efficiently. In the design shown, the largest outer diameter D18 in the area of the planet carrier 18 is in particular smaller than 1.25 times the largest outer diameter D19 in the area of the differential carrier 19. Furthermore, the carrier element is designed in such a way that the planet gears 17 rotatably mounted therein have at least partial axial overlap with the neighboring side gear 6. This contributes to a compact design.

It can also be seen that the planet carrier 18 has several circumferentially distributed windows 68, respectively apertures through which the planet gears 17 pass or extend. On the inside, the planet gears 17 engage with the sun gear 15 and on the outside with the ring gear 16. In the present case, the axial distance B3 from the window center plane E68 to the differential center plane E25 is smaller than the axial distance B4 from the differential center plane E25 to the lateral bearing 69, via which the differential carrier 19 is rotatably mounted in the outer housing, in particular smaller than 0.9 times or 0.8 times the axial distance B4. This also supports a compact design.

An intermediate shaft 23 is connected in a rotationally fixed manner to the first side gear 6 in order to transmit a torque to a side shaft (not shown) to be connected thereto at the other end. The intermediate shaft 23 extends through the hollow shaft 10, wherein an annular space 24 with two end openings is formed between the two. A second intermediate or side shaft (not shown) is connected to the second side gear 7 for torque transmission to an associated second vehicle wheel.

The housing 8 of the electric drive 2 comprises a first housing part 31, which forms a receiving chamber for the electric machine 3, a second housing part 32, in which the gear unit 4, 5 is at least partially accommodated, and an intermediate housing part 33, which is arranged between the two end-sided housing parts 31, 32. The intermediate housing part 33 has an intermediate wall 34, which spatially separates an engine compartment 35 and a transmission compartment 36 from one another, which can also be referred to as chambers. The motor compartment 35 can be dry, i.e. lubricant-free, and sealed off from the outside by means of corresponding seals 26, 27, 28, 29, while the transmission compartment 36 can be filled with lubricant.

A friction disc clutch 41, which is arranged in the differential carrier 19, is provided to control the locking effect of the differential. The disc clutch 41 is effectively arranged between the differential carrier 19 and a side gear 7. Actuating the clutch in the closing direction thus creates a locking effect between the differential carrier and the side gear. The clutch comprises outer discs 42, which are connected to the differential carrier 19 in a rotationally fixed and axially movable manner, and inner discs 43, which are connected to the second side gear 7 in a rotationally fixed and axially movable manner. The rotationally fixed connection can be a form-fitting connection, for example. The disc pack formed by the outer discs and inner discs can be axially loaded via a pressure plate 44. The pressure force is controlled by means of a ball ramp mechanism 45. The force is transmitted from the ball ramp mechanism 45 to the pressure plate 44 via several force transmission elements 46 distributed around the circumference, which are shown here in dashed lines. The force transmission elements are designed in particular as bolts that extend axially through through-holes in the differential carrier 19. At one end, the bolts are axially supported against an actuating element 55, and at the other end against the pressure plate 44.

The pressure plate 44 acts on the disc pack, which reduces the compensating movement between side gear 6 and differential carrier 19, and therefore also between the two side gears 6, 7. The torque that can be transmitted by the disc clutch 41 can be variably adjusted as required by controlling the ball ramp mechanism 4 accordingly. The clutch can be fully open, so that the two side gears can rotate freely relative to each other (“open” differential), or fully closed, so that a balancing respectively differential movement of the side gears is completely blocked (“closed” differential), or it can be operated in any intermediate state, so that a balancing, respectively differential movement between the side gears is partially blocked.

The ball ramp mechanism 45 is arranged coaxially to the differential carrier 19 and drivable by a drive source located in a different sectional plane and therefore not shown here. In particular, the differential carrier 19 has a side wall portion 47, through which the power transmission elements extend, and an axially adjoining sleeve portion 48, around which the ball ramp mechanism 45 is arranged. An annular gap is formed between an outer face of the sleeve portion 48 and at least some components of the ball ramp mechanism 45. The side wall portion 47 is inserted into a recess 49 of the casing portion of the differential carrier 19 and firmly connected thereto, for example by welding.

The ball ramp mechanism 45 comprises a support ring 50, which is axially supported on the sleeve portion 48, and an setting ring 51, which is axially movable relative to the support ring. In an exemplary embodiment, the support ring 50 is rotatably drivable by a drive source, while the setting ring 51 is held in a rotationally fixed position relative to a stationary housing part by anti-rotation means. For actuation, the support ring 50 has a toothed segment 52 in which a pinion can engage for rotary drive. It is understood that other designs are also possible, for example with a rotatably drivable setting ring or other forms of torque transmission, such as by a toothed rack or spindle drive.

The support ring 50 and the setting ring 51 each have a plurality of ball grooves 53, 54 extending in the circumferential direction on their end faces facing each other, with a ball accommodated respectively guided in each pair of ball grooves. The balls are located in a different sectional plane and are therefore not visible here. The ball grooves 53, 54 are designed in such a way that a rotary movement introduced into the support ring 50 by the drive source is converted into an axial movement of the setting ring 51. For this purpose, the setting ring 51 and the support ring 50 can each have a decreasing depth in the same circumferential direction when viewed from above on the end faces. However, a design in which only one of the two discs has ball grooves is also possible. In the present case, the setting ring 51 is mounted radially relative to the support ring 50 exclusively via the balls. Accordingly, no radial bearing relative to the differential carrier is required, so that in particular the sleeve portion 48 can be designed favorably with regard to the loads occurring during operation.

An annular actuating element 55 is provided to transmit force between the ball ramp mechanism 45 and the clutch. The actuating element 55 is arranged coaxially to the ball ramp mechanism 45 between the setting ring 51 and the side wall of the differential carrier 19 so that it can move axially. The actuating element 55 can be centered relative to the axis of rotation A, respectively to the sleeve portion 48, via the force transmission elements 46 connected thereto. The force transmission between the setting ring 51 and the actuating element 55 can be effected via an optional axial bearing 57. The axial bearing 57 is arranged coaxially to the ball ramp mechanism 45; it transmits axial forces and decouples relative rotational movements. The axial bearing 57 is radially supported relative to the actuating element 55. For this purpose, the actuating element 55 has an axially projecting, in particular circumferential collar on its side facing the setting ring 51, which forms a recess for the axial bearing 57.

An axial movement of the setting ring 51 is transmitted to the pressure plate 44 via the axial bearing 57, the actuating element 55 and the force transmission elements 46.

A spring element 56 is used for resetting, which is arranged axially between the differential carrier 19 and the actuating element 55 to exert a resilient restoring force on the actuating element 55 that counteracts the actuating force of the ball ramp mechanism 45. The spring element 56 is designed in the present case as a disc spring in a coaxial arrangement to the sleeve portion, respectively actuating element, wherein it is understood that other spring forms are possible as return springs. For radial positioning and/or for a short axial design, spring element 56 can be arranged at least partially in a recess 67 or axial depression of the side wall portion 47 of the differential carrier 19.

The actuating element 55, the axial bearing 57, the support ring 50 and the setting ring 51 are radially spaced from an outer face of the sleeve portion 48. The support ring 50 of the ball ramp mechanism is axially supported against the sleeve portion 48. The differential carrier 19 has a bearing seat 39 on which a rotary bearing 40 is mounted, which is designed in particular as a combined axial/radial bearing. The bearing is axially supported against the sleeve portion 48 by a retaining ring, although other designs are possible. The differential carrier 19 has a concave transition portion 30 between the side wall portion 47 and the bearing seat 39, which extends axially from the side face approximately as far as the support ring 50. The transition portion 30 has a free outer surface, i.e. no components are arranged or mounted on the differential carrier between the side face and the rotary bearing 40. A smallest outer diameter D30 of the concave transition portion 30 can be smaller than the outer diameter D39 of the bearing seat 39 for the rotary bearing 40. A curvature of the concave transition portion 30 can have a radius which is at least 0.5 times a smallest axial distance between the setting ring 51 and the side wall of the differential carrier 19.

A special feature of the electric drive is its compact design. The design of the second side gear 7 and the differential carrier 19 in particular contribute to this. The second side gear 7 has internal gearing 58, in particular inner splines, for inserting a second intermediate shaft (not shown) and a disc carrier portion 59 for the disc clutch 41. The internal gearing for the shaft connection and the disc carrier portion have at least partial axial overlap, resulting in an axially compact design.

On its hub section, respectively outer side, the second side gear 7 comprises engagement means in which the inner discs 43 of the disc clutch engage in a rotationally fixed and axially movable manner. In this respect, the disc carrier portion 59 can also be described as an inner disc carrier. The disc pack can be axially loaded by the pressure plate 44 and is axially supported against an optional support plate 60 arranged in the differential carrier 19. The outer disc carrier, to which the outer discs 42 are connected in a rotationally fixed and axially movable manner, is formed in the differential cage 19.

The support plate 60 is designed in particular such that the inner diameter d60 is smaller than the smallest inner diameter D61 of the differential insertion opening 61 and/or smaller than the mean diameter D41 of the disc pack and/or smaller than the largest outer diameter D7 of the second side gear 7. The insertion opening 61 of the differential carrier 19 can be designed to be larger than the mean diameter D41 of the disc pack. On the side facing the differential gear set, the support ring may have an annular face 62 that tapers in the direction of the disc pack, in particular a conical annular face 62. In this way, a radially outer section of the side gear 7 can be arranged with axial overlap to the support plate 60 and/or as close as possible axially to the disc pack. The support plate 60 may have a holding section 63 that protrudes axially from the rear support face and is seated in the insertion opening 61 of the differential carrier 19. In this way, the support plate 60 is held and/or centered radially relative to the differential carrier 19.

FIG. 2 is a schematic representation of an electric drive assembly 2, in which the planetary gears 17 have only one planet gear toothing 37.

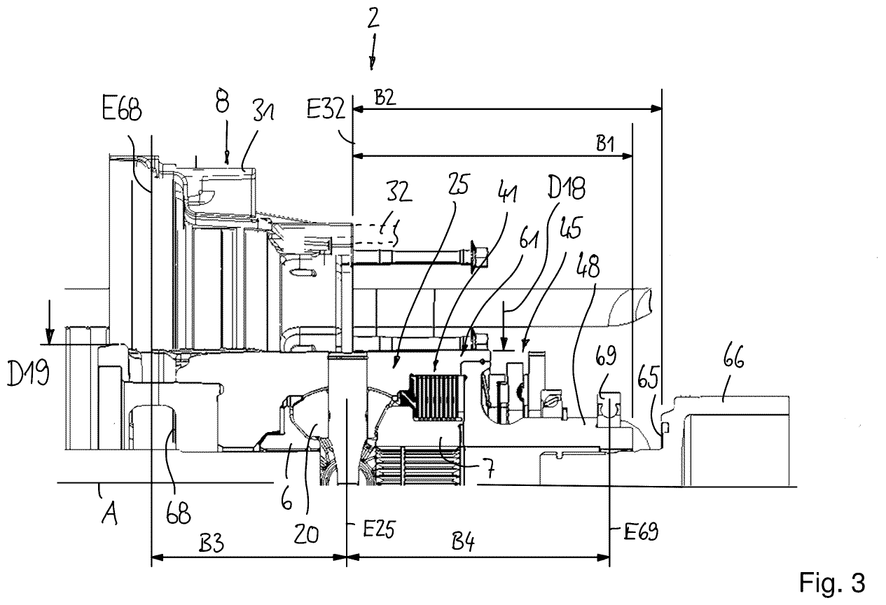

FIG. 3 shows the differential unit of an electric drive assembly in a slightly modified embodiment in longitudinal section. A special feature of this embodiment is that the parting plane E32 of the housing 8 is arranged between the intermediate housing part and the end-side second housing part 32 in axial overlap with a central section of the differential. In particular, it is provided that an axial distance B1 between the parting plane E32 of the second housing part 32 and an end face 64 of the differential carrier, respectively its sleeve portion 48 is less than 150 mm, and/or that an axial distance B2 between the parting plane E32 and an outer joint part 66 of a constant velocity joint not shown further, which is to be connected to the side gear 7, is less than 155 mm. A factor representative of the axial size from the axial distance B2, specified in millimeters, and the transmissible coupling torque, specified in Nm, can be less than 1.0, in particular less than 0.9. These features contribute individually or jointly to an axially compact design.

An electric drive assembly offers the advantage of integrating a controllable clutch for limiting the balancing, respectively differential effect of the differential gearing as required, while at the same time having a compact design with a smaller number of parts. Overall, this achieves an improvement in the driving dynamics properties, with only minor adjustments to the packaging required on the vehicle side.

1. An electric drive assembly for driving a motor vehicle, comprising:
a housing,
an electric machine with a motor shaft formed as a hollow shaft, which is rotatably drivable by the electric machine about an axis of rotation;
a planetary gearing with a sun gear, a ring gear, a plurality of planet gears and a planet carrier, on which the planet gears are rotatably arranged, wherein the sun gear is rotatably drivable by the hollow shaft about the axis of rotation, and the ring gear is connected to the housing in a rotationally fixed manner,
a differential unit with a differential, a disc clutch for adjusting a locking effect of the differential and a controllable ball ramp mechanism for operating the disc clutch,
wherein a differential carrier of the differential and the planet carrier form a unitary carrier element which is rotatably mounted in the housing about the axis of rotation,
wherein a first side gear of the differential is connected to a first intermediate shaft extending through the hollow shaft of the electric machine, and a second side gear of the differential has inner splines for inserting a second intermediate shaft and a disc carrier portion for on which a disc pack of the disc clutch is arranged, wherein the inner splines and the disc carrier portion have at least partial axial overlap,
wherein the ball ramp mechanism is arranged outside the differential carrier coaxially around a sleeve portion of the differential carrier and has an axially supported support ring and an axially movable setting ring,
wherein the differential carrier has a side wall portion with a plurality of through openings distributed over the circumference, through which force transmission elements extend axially to transmit an axial movement of the setting ring to a pressure plate for loading the disc pack.

2. The electric drive assembly according to claim 1, wherein a largest outer diameter of the carrier element in the region of the planet carrier is smaller than 1.25 times a largest outer diameter of the carrier element in the region of the differential cage.

3. The electric drive assembly according to claim 1, wherein the planet carrier has a plurality of radial windows arranged over the circumference, through which the planet gears pass and which form a window centre plane, wherein an axial distance from the window centre plane to a differential centre plane is smaller than an axial distance from the differential centre plane to an end-side bearing by which the differential carrier is rotatably mounted in the housing.

4. The electric drive assembly according to claim 1, wherein the disc pack includes outer discs connected to the differential carrier in a rotationally fixed and axially movable manner and inner discs connected to the second side gear in a rotationally fixed and axially movable manner, wherein the disc pack is axially loadable via the pressure plate and is axially supported against the differential carrier via a contact surface associated therewith.

5. The electric drive assembly according to claim 1, wherein the differential carrier has an opening for inserting the second side gear, wherein a smallest inner diameter of the opening is larger than a mean diameter of the disc pack of the disc clutch.

6. The electric drive assembly according to claim 1, wherein an annular support plate is arranged in the differential carrier, via which the disc pack is axially supported against the differential carrier, the support plate having an inner diameter which is smaller than at least one of the smallest inner diameter of the opening, the mean diameter of the disc pack, and than a largest outer diameter of the second side gear.

7. The electric drive assembly according to claim 6, wherein the support plate has a support face axially supported against the differential carrier and a holding section projecting axially therefrom, the holding section being seated in the opening of the differential carrier, so that the support plate is held radially relative to the differential carrier.

8. The electric drive assembly according to claim 1, wherein the differential carrier includes a side wall portion which adjoins the sleeve portion and through which the force transmission elements extend, with an actuating element arranged coaxially with the sleeve portion between the support disc of the ball ramp mechanism and the force transmission elements, with an annular gap formed between an outer surface of the sleeve portion and the actuating element.

9. The electric drive assembly according to claim 8, wherein the side wall portion is inserted into a recess of the casing portion of the differential carrier and is firmly connected thereto by welding.

10. The electric drive assembly according to claim 1, wherein the sleeve portion of the differential carrier has a bearing seat on which a rotary bearing for the support ring is seated, wherein the differential carrier comprises a concave transition portion between the side wall portion and the bearing seat of the sleeve portion, which transition portion extends axially from a side face of the side wall portion at least as far as the setting ring.

11. The electric drive assembly according to claim 8, wherein a spring element is arranged axially between the side wall portion and the actuating element so as to exert a spring return force on the actuating element opposite to the actuating force of the ball ramp mechanism, with the side wall portion having a recess in which the spring element is at least partially arranged.
